(19) United States
(12) Patent Application Publication
(10) Pub. No.: US 2024/0141509 A1
(43) Pub. Date: May 2, 2024

(54) WATER ELECTROLYSIS CELL

(71) Applicant: TOYOTA JIDOSHA KABUSHIKI KAISHA, Toyota-shi (JP)

(72) Inventors: Hikaru HASEGAWA, Numazu-shi (JP); Kohsei YOSHIDA, Gotenba-shi (JP); Toshio FUKUDA, Toyota-shi (JP)

(73) Assignee: TOYOTA JIDOSHA KABUSHIKI KAISHA, Toyota-shi (JP)

(21) Appl. No.: 18/462,361

(22) Filed: Sep. 6, 2023

(30) Foreign Application Priority Data
Nov. 1, 2022 (JP) 2022-175287

(51) Int. Cl. C25B 1/04; C25B 9/63; C25B 13/02

(52) U.S. Cl. CPC C25B 1/04; C25B 9/63; C25B 13/02

(57) ABSTRACT

A water electrolysis cell includes a separator having, on its front and back, grooves serving as channels. The separator has, in its ends in a planar direction, an oxygen electrode- side supply hole, an oxygen electrode-side discharge hole, a hydrogen electrode-side supply hole, a hydrogen electrode-side discharge hole, an inter-cell channel supply hole, and an inter-cell channel discharge hole, as viewed in plan. A sealing member surrounding the oxygen electrode-side supply hole and a sealing member surrounding the oxygen electrode- side discharge hole, as viewed in plan, are located in the separator, but no sealing members are located around the hydrogen electrode-side supply hole, the hydrogen electrode-side discharge hole, the inter-cell channel supply hole, and the inter-cell channel discharge hole.

### CROSS-REFERENCE TO RELATED APPLICATION

This application claims priority to Japanese Patent Application No. 2022-175287 filed on Nov. 1, 2022, incorporated herein by reference in its entirety.

### BACKGROUND

### 1. Technical Field

The present disclosure relates to water electrolysis cells.

### 2. Description of Related Art

Various studies have been made on water electrolysis devices. For example, Japanese Unexamined Patent Application Publication No. 2016-060944 (JP 2016-060944 A) discloses a technique of reducing lifting of an electrode portion by disposing a pressing load application mechanism in a water electrolysis cell in a differential pressure type high pressure water electrolysis device.

### SUMMARY

There is a need to increase the pressure inside a water electrolysis cell (hereinafter sometimes referred to as “cell”) in order to increase the pressure of hydrogen generated by water electrolysis. The conventional cell has a problem that a separator of the cell is deformed by the load application mechanism. Increasing the thickness of the separator in order to reduce the deformation of the separator may increase the weight of the cell.

The present disclosure was made in view of the above circumstances, and it is a primary object of the present disclosure to provide a water electrolysis cell capable of reducing deformation of a separator.

The present disclosure provides a water electrolysis cell. The water electrolysis cell includes a separator having, on front and back of the separator, grooves serving as channels. The separator has, in ends of the separator in a planar direction, an oxygen electrode-side supply hole, an oxygen electrode-side discharge hole, a hydrogen electrode-side supply hole, a hydrogen electrode-side discharge hole, an inter-cell channel supply hole, and an inter-cell channel discharge hole, as viewed in plan. A sealing member surrounding the oxygen electrode-side supply hole and a sealing member surrounding the oxygen electrode-side discharge hole, as viewed in plan, are located in the separator, but no sealing members are located around the hydrogen electrode-side supply hole, the hydrogen electrode-side discharge hole, the inter-cell channel supply hole, and the inter-cell channel discharge hole.

In the present disclosure, the water electrolysis cell may further include an electrode portion; a support frame including an opening portion surrounding the electrode portion; and a pair of the separators sandwiching the electrode portion and the support frame between the separators.

The water electrolysis cell of the present disclosure can reduce deformation of the separator.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic partial sectional view showing an example of part of a water electrolysis cell, illustrating a problem of a conventional water electrolysis cell;

FIG. 2 is a schematic plan view showing an example of the conventional water electrolysis cell as viewed in plan; and

FIG. 3 is a schematic plan view showing an example of a water electrolysis cell of the present disclosure as viewed in plan.

### DETAILED DESCRIPTION OF EMBODIMENTS

An embodiment according to the present disclosure will be described below. Any matters not specifically mentioned in the present specification but necessary to carry out the present disclosure (e.g., the general configuration and manufacturing process of a water electrolysis cell that do not characterize the present disclosure) can be construed as design matters for a person skilled in the art based on the related art in this field. The present disclosure can be carried out based on the content disclosed in the present specification and the common general technical knowledge in the field. The dimensional ratios (length, width, thickness, etc.) in the drawings do not reflect actual dimensional ratios. In the present specification, the word “to” indicating a numerical range means to include the numerical values before and after the word “to” as a lower limit value and an upper limit value. Any combination of upper and lower limit values in the numerical range can be adopted.

The present disclosure provides a water electrolysis cell. The water electrolysis cell includes a separator having, on its front and back, grooves serving as channels. The separator has, in its ends in a planar direction, an oxygen electrode-side supply hole, an oxygen electrode-side discharge hole, a hydrogen electrode-side supply hole, a hydrogen electrode-side discharge hole, an inter-cell channel supply hole, and an inter-cell channel discharge hole, as viewed in plan. A sealing member surrounding the oxygen electrode-side supply hole and a sealing member surrounding the oxygen electrode-side discharge hole, as viewed in plan, are located in the separator, but no sealing members are located around the hydrogen electrode-side supply hole, the hydrogen electrode-side discharge hole, the inter-cell channel supply hole, and the inter-cell channel discharge hole.

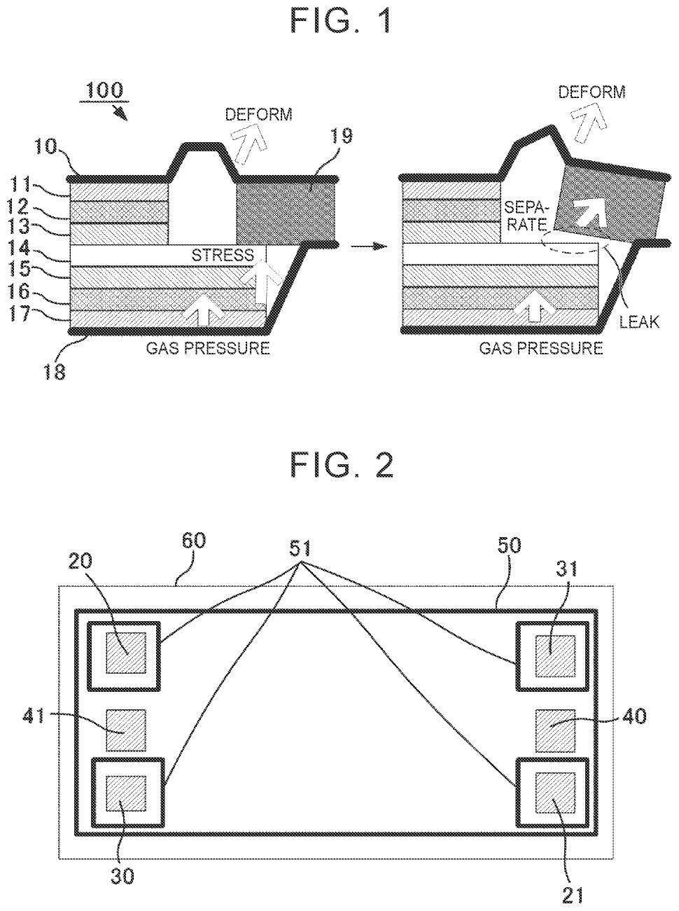

FIG. 1 is a schematic partial sectional view showing an example of part of a water electrolysis cell, illustrating a problem of a conventional water electrolysis cell. As shown in FIG. 1, a conventional water electrolysis cell 100 includes an anode separator 10, an anode-side gas diffusion layer 11, an anode-side microporous layer 12, an anode catalyst layer 13, an electrolyte membrane 14, a cathode catalyst layer 15, a cathode-side microporous layer 16, a cathode-side gas diffusion layer 17, a cathode separator 18, and a support frame 19.

FIG. 2 is a schematic plan view showing an example of the conventional water electrolysis cell as viewed in plan. As shown in FIG. 2, a separator 60 of the conventional water electrolysis cell has, in its ends in a planar direction, an oxygen electrode- side supply hole 20, an oxygen electrode-side discharge hole 21, a hydrogen electrode-side supply hole 30, a hydrogen electrode-side discharge hole 31, an inter-cell channel supply 30 hole 40, and an inter-cell channel discharge hole 41. In the separator 60, the oxygen electrode-side supply hole 20, the oxygen electrode-side discharge hole 21, the hydrogen electrode-side supply hole 30, the hydrogen electrode-side discharge hole 31, the inter-cell channel supply hole 40, and the inter-cell channel discharge hole 41 are surrounded by an outer peripheral sealing member 50. Each of the oxygen electrode-side supply hole 20, the oxygen electrode-side discharge hole 21, the hydrogen electrode-side supply hole 30, and the hydrogen electrode-side discharge hole 31 is surrounded by a corresponding one of sealing members 51. The outer peripheral sealing member 50 and the sealing members 51 may be made of the same material or different materials.

As shown in FIG. 2, in the conventional cell used as a fuel cell, it is necessary to individually seal channels for the following three fluids: hydrogen, oxygen or an oxygen-containing gas such as air, and a cooling medium. Therefore, the spaces in the channels are independent of each other. When the pressure of a hydrogen electrode is increased as shown on the left side in FIG. 1 in order to increase the pressure of hydrogen to be generated, a differential pressure is generated between inside the cell and between the cells, and the anode separator 10 is deformed. As shown on the right side in FIG. 1, the support frame 19 is pulled as the anode separator 10 is deformed. Therefore, the seal of the support frame 19 is separated from the electrolyte membrane 14, causing leakage.

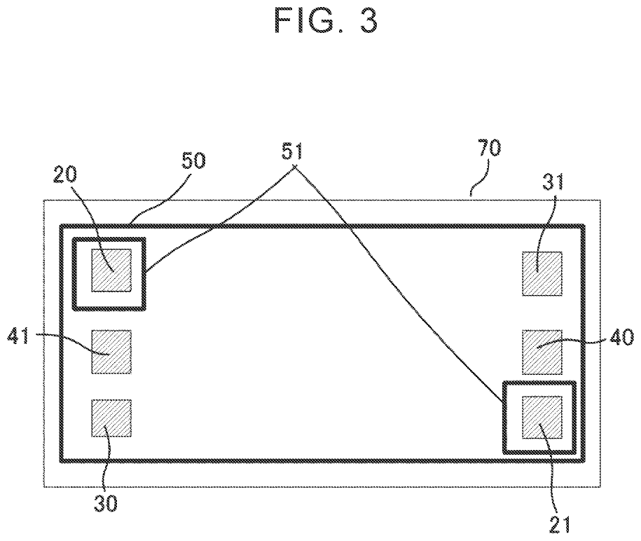

FIG. 3 is a schematic plan view showing an example of the water electrolysis cell of the present disclosure as viewed in plan. In FIG. 3, the same configurations as those in FIG. 2 are denoted by the same signs as those in FIG. 2, and description thereof will be omitted. As shown in FIG. 3, in a separator 70 of the water electrolysis cell of the present disclosure, each of the oxygen electrode-side supply hole 20 and the oxygen electrode-side discharge hole 21 is surrounded by a corresponding one of the sealing members 51. On the other hand, the hydrogen electrode-side supply hole 30 and the hydrogen electrode-side discharge hole 31 are not surrounded by the sealing members 51, so that the spaces in cathode fluid channels and the spaces in cooling medium channels are connected.

In the present disclosure, no sealing members are located around the hydrogen electrode-side supply hole and the hydrogen electrode-side discharge hole that form hydrogen electrode manifolds and the inter-cell channel supply hole and the inter-cell channel discharge hole that form cooling medium manifolds of the cooling medium channels between the cells. The spaces in the cathode fluid channels and the spaces in the cooling medium channels are thus connected, so that the pressure between the cells becomes equal to the pressure of the hydrogen electrode inside the cell. This configuration reduces leakage.

In the present disclosure, the cooling medium can be caused to flow inside the cell by using the separator having the cooling medium channels. This reduces heat generation inside the cell and improves durability of the cell, the seal members, etc. Moreover, since a conventional cell for a fuel cell can be used as the water electrolysis cell, cost reduction can be achieved.

As will be described below, the water electrolysis cell of the present disclosure electrolyzes water supplied to an anode (oxygen electrode) to generate oxygen from the anode and hydrogen from a cathode (hydrogen electrode).

Anode: H₂O→2H⁺+½O₂+2e⁻

Cathode: 2H⁺+2e⁻→H₂

The water electrolysis cell of the present disclosure may be a water electrolysis cell stack (hereinafter sometimes referred to as “stack”) consisting of a stack of a plurality of the water electrolysis cells. The number of water electrolysis cells in the stack is not particularly limited. For example, the stack may consist of two water electrolysis cells to several hundreds of water electrolysis cells. The water electrolysis cell of the present disclosure includes a separator, and may usually include an electrode portion, a support frame having an opening portion surrounding the electrode portion, and a pair of the separators sandwiching the electrode portion and the support frame therebetween.

One of the pair of separators is an anode separator, and the other is a cathode separator. The anode separator and the cathode separator are collectively referred to as “separators.” The two separators, namely the anode separator and the cathode separator, sandwich the electrode portion and the support frame therebetween. The separator has holes that form manifolds, such as supply holes and discharge holes for causing fluids such as reactant water, oxygen, hydrogen, and cooling medium to flow in a stacking direction of the water electrolysis cells. Examples of the reactant water and the cooling medium include water, pure water, and alkaline water. Specifically, the separator has, in its ends in a planar direction, an oxygen electrode-side supply hole, an oxygen electrode-side discharge hole, a hydrogen electrode-side supply hole, a hydrogen electrode-side discharge hole, an inter-cell channel supply hole, and an inter-cell channel discharge hole, as viewed in plan. The oxygen electrode-side supply hole supplies the reactant water to an oxygen electrode. The oxygen electrode-side discharge hole discharges oxygen generated by water electrolysis from the oxygen electrode. The hydrogen electrode-side supply hole may not be used during water electrolysis, and may supply the cooling medium to a hydrogen electrode during water electrolysis. The hydrogen electrode-side discharge hole discharges hydrogen generated by water electrolysis from the hydrogen electrode. The inter-cell channel supply hole supplies the cooling medium between the cells of the water electrolysis cell stack. The inter-cell channel discharge hole discharges the cooling medium from between the cells of the water electrolysis cell stack.

The separator has, on its front and back, grooves serving as channels. Specifically, the separator may have channels for a reactant fluid such as reactant water, oxygen, or hydrogen in its surface that contacts a gas diffusion layer. The separator may have channels for the cooling medium for keeping the temperature of the water electrolysis cell constant in its opposite surface from the surface that contacts the gas diffusion layer, namely between the cells. The anode separator may have channels for an anode fluid such as reactant water and oxygen in its surface that contacts an anode-side gas diffusion layer. The anode separator may have channels for the cooling medium for keeping the temperature of the water electrolysis cell constant in its opposite surface from the surface that contacts the anode-side gas diffusion layer. The cathode separator may have channels for a cathode fluid such as hydrogen in its surface that contacts a cathode-side gas diffusion layer. The cathode separator may have channels for the cooling medium for keeping the temperature of the water electrolysis cell constant in its opposite surface from the surface that contacts the cathode-side gas diffusion layer. The separator may be a gas-impermeable electroconductive member etc. Examples of the electroconductive member include: gas-impermeable dense carbon produced by compressing a resin material such as thermosetting resin, thermoplastic resin, or resin fiber and a carbon material such as carbon powder or carbon fiber; and press- formed metal (e.g., titanium, stainless steel, etc.) plates. The shape of the separator may be a rectangle, a horizontally elongated hexagon, a horizontally elongated octagon, a circle, an ellipse, etc.

A sealing member surrounding the oxygen electrode-side supply hole and a sealing member surrounding the oxygen electrode-side discharge hole, as viewed in plan, are located in the separator, but no sealing members are located around the hydrogen electrode-side supply hole, the hydrogen electrode-side discharge hole, the inter-cell channel supply hole, and the inter-cell channel discharge hole. The sealing member may be a conventionally known gasket, resin sheet, etc.

The water electrolysis cell may include the electrode portion. The electrode portion includes the anode-side gas diffusion layer, an anode catalyst layer, an electrolyte membrane, a cathode catalyst layer, and the cathode-side gas diffusion layer in this order. The electrode portion may include the anode-side gas diffusion layer, an anode-side microporous layer, the anode catalyst layer, the electrolyte membrane, the cathode catalyst layer, a cathode-side microporous layer, and the cathode-side gas diffusion layer in this order, as necessary. From the viewpoint of reducing plastic deformation of the electrolyte membrane due to a differential pressure between the hydrogen electrode and the oxygen electrode, the electrode portion may include at least the cathode-side microporous layer out of the anode-side microporous layer and the cathode-side microporous layer.

The cathode (hydrogen electrode) includes the cathode catalyst layer and the cathode-side gas diffusion layer, and as necessary, includes the cathode-side microporous layer between the cathode catalyst layer and the cathode-side gas diffusion layer. The anode (oxygen electrode) includes the anode catalyst layer and the anode-side gas diffusion layer, and as necessary, includes the anode-side microporous layer between the anode catalyst layer and the anode-side gas diffusion layer. In the water electrolysis cell, the area of one of the two electrodes, namely the oxygen electrode and the hydrogen electrode, may be smaller than that of the other, or the area of the oxygen electrode may be smaller than that of the hydrogen electrode. The electrode portion of the water electrolysis cell therefore has a stepped structure at its ends in the planar direction. Each of the catalyst layer, microporous layer, and gas diffusion layer of the electrode having a smaller area out of the oxygen electrode and the hydrogen electrode may have any area as long as the areas of the catalyst layer, microporous layer, and gas diffusion layer of this electrode are smaller than the area of the electrolyte membrane. The relation among the areas of the catalyst layer, microporous layer, and gas diffusion layer of the electrode having a smaller area out of the oxygen electrode and the hydrogen electrode is not particularly limited as long as the areas of the catalyst layer, microporous layer, and gas diffusion layer of this electrode are smaller than the area of the electrolyte membrane. In the water electrolysis cell of the present disclosure, the pressure of the hydrogen electrode inside the water electrolysis cell may be made higher than that of the oxygen electrode.

The cathode catalyst layer and the anode catalyst layer are collectively referred to as “catalyst layers.” The catalyst layer may include, for example, a catalyst metal that accelerates an electrochemical reaction, a proton-conductive electrolyte, and an electron-conductive support. Examples of the catalyst metal include iridium (Ir), iridium dioxide (IrO₂), ruthenium (Ru), platinum (Pt), and alloys of Pt and other metals (e.g., Pt alloys containing cobalt or nickel). Examples of the catalyst metal include Ir, IrO₂, and Ru for the anode catalyst layer, and include Pt and Pt alloys for the cathode catalyst layer. The electrolyte may be, for example, a fluororesin. The fluororesin may be, for example, a Nafion solution. The catalyst metal is supported on the support. Each catalyst layer may include the support supporting the catalyst metal (catalyst-supporting support) and the electrolyte. Examples of the support that supports the catalyst metal include carbon materials such as commercially available carbon.

The electrolyte membrane may be a solid polymer electrolyte membrane. Examples of the solid polymer electrolyte membrane include fluorine-based electrolyte membranes such as a thin perfluorosulfonic acid membrane containing moisture and hydrocarbon-based electrolyte membranes. The electrolyte membrane may be, for example, a Nafion membrane (made by DuPont).

The cathode-side gas diffusion layer and the anode-side gas diffusion layer are collectively referred to as “gas diffusion layers.” The gas diffusion layer may be, for example, an electroconductive member having gas permeability, namely having pores. Examples of the electroconductive member include porous carbon materials such as carbon cloth and carbon paper, and porous metal materials such as metal mesh and metal foam.

The anode-side microporous layer and the cathode-side microporous layer are collectively referred to as “microporous layers.” The microporous layer may be a mixture of a water-repellent resin such as polytetrafluoroethylene (PTFE) and an electroconductive material such as carbon black. The microporous layer may have pores of one micrometer to several hundreds of micrometers.

The support frame is disposed around the periphery of the electrode portion and between the cathode separator and the anode separator. The support frame may have a framework portion, an opening portion, and holes. The framework portion is the main part of the support frame that connects to the electrode portion. The opening portion is a region that holds the electrode portion, and is a region extending through part of the framework portion in order to house the electrode portion. The opening portion may be located at any position in the support frame as long as the framework portion is disposed around (in the peripheral portion of) the electrode portion, and may be located in the center of the support frame. The holes in the support frame cause the fluids such as reactant water, oxygen, hydrogen, and cooling medium to flow in the stacking direction of the water electrolysis cells. The holes in the support frame may be aligned with the holes in the separators so as to communicate with these holes. The support frame may include a frame-shaped core layer and two frame-shaped shell layers provided on both sides of the core layer, that is, a first shell layer and a second shell layer. The first shell layer and the second shell layer may be provided in a frame shape on both sides of the core layer in a manner similar to that of the core layer.

The core layer may be any structural member having gas sealing properties and insulating properties, and may be made of a material whose structure does not change under temperature conditions during thermocompression bonding in a manufacturing process of the water electrolysis cell. Specific examples of the material of the core layer include resins such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyetheretherketone (PEEK), cycloolefin, polyethersulfone (PES), polyphenylsulfone (PPSU), liquid crystal polymer (LCP), and epoxy resin. The material of the core layer may be a rubber material such as ethylene propylene diene rubber (EPDM), fluororubber, or silicone rubber. The thickness of the core layer may be 5 μm or more, or 20 μm or more, from the viewpoint of ensuring insulation performance, and may be 200 μm or less, or 150 μm or less, from the viewpoint of reducing the thickness of the water electrolysis cell.

The first shell layer and the second shell layer may have such properties that the first and second shell layers are highly adhesive to other materials, soften under temperature conditions during thermocompression bonding, and have lower viscosity and a lower melting point than the core layer, in order to bond the core layer to the anode separator and the cathode separator and ensure sealing performance. Specifically, the first shell layer and the second shell layer may be made of a thermoplastic resin such as a polyester-based thermoplastic resin or a modified olefin-based thermoplastic resin, or may be made of a thermosetting resin that is a modified epoxy resin. The resin of the first shell layer and the resin of the second shell layer may be the same type of resin or may be different types of resin. Providing the shell layers on both sides of the core layer facilitates adhesion between the support frame and the two separators by hot pressing. The thickness of each of the first shell layer and the second shell layer may be 5 μm or more, or 30 μm or more, from the viewpoint of ensuring adhesion performance, and may be 100 μm or less, or 40 μm or less, from the viewpoint of reducing the thickness of the water electrolysis cell.

The support frame may have the first shell layer and the second shell layer only in its regions to be bonded to the anode separator and the cathode separator, respectively. The first shell layer provided on one side of the core layer may be bonded to the cathode separator. The second shell layer provided on the other side of the core layer may be bonded to the anode separator. The support frame may be sandwiched between the pair of separators.

The water electrolysis cell stack may have manifolds such as inlet manifolds with which each supply hole communicates and outlet manifolds with which each discharge hole communicates. The inlet manifolds include, for example, an oxygen electrode inlet manifold, a hydrogen electrode inlet manifold, and a cooling medium inlet manifold. The outlet manifolds include, for example, an oxygen electrode outlet manifold, a hydrogen electrode outlet manifold, and a cooling medium outlet manifold. The oxygen electrode inlet manifold and the oxygen electrode outlet manifold are collectively referred to as “oxygen electrode manifolds.” The hydrogen electrode inlet manifold and the hydrogen electrode outlet manifold are collectively referred to as “hydrogen electrode manifolds.” The cooling medium inlet manifold and the cooling medium outlet manifold are collectively referred to as “cooling medium manifolds.”

What is claimed is:

1. A water electrolysis cell comprising a separator having, on front and back of the separator, grooves serving as channels, wherein:
the separator has, in ends of the separator in a planar direction, an oxygen electrode- side supply hole, an oxygen electrode-side discharge hole, a hydrogen electrode-side supply hole, a hydrogen electrode-side discharge hole, an inter-cell channel supply hole, and an inter-cell channel discharge hole, as viewed in plan; and
a sealing member surrounding the oxygen electrode-side supply hole and a sealing member surrounding the oxygen electrode-side discharge hole, as viewed in plan, are located in the separator, but no sealing members are located around the hydrogen electrode-side supply hole, the hydrogen electrode-side discharge hole, the inter-cell channel supply hole, and the inter-cell channel discharge hole.

2. The water electrolysis cell according to claim 1, further comprising:
an electrode portion;
a support frame including an opening portion surrounding the electrode portion; and
a pair of the separators sandwiching the electrode portion and the support frame between the separators.
